(19) United States
(12) Patent Application Publication
(10) Pub. No.: US 2023/0278535 A1
(43) Pub. Date: Sep. 7, 2023

(54) BRAKE SYSTEM

(71) Applicant: ZF Active Safety GmbH, Koblenz (DE)

(72) Inventors: Andreas Marx, Hartenfels (DE); Nicholas Alford, Waldesch (DE)

(21) Appl. No.: 18/176,510

(22) Filed: Mar. 1, 2023

(30) Foreign Application Priority Data
Mar. 1, 2022 (DE) 102022104851.9

(51) Int. Cl. B60T 8/88; B60T 7/04; B60T 13/74

(52) U.S. Cl. CPC B60T 8/885; B60T 7/042; B60T 13/746; B60T 2270/82; B60T 2220/04; B60T 2270/402; B60T 2270/404; B60T 2270/413; B60T 2270/414

(57) ABSTRACT

A brake-by-wire brake system for a vehicle having at least two wheels which can be braked is specified. The brake system comprises at least two brake actuator units, which each have a brake actuator assigned to one of the wheels, which can be braked, for braking the vehicle during driving operation. The brake system furthermore comprises a brake actuation unit for actuation by the driver for a braking operation, having at least one sensor for detecting an activation of the brake actuation unit by the driver, at least one electronic control unit which is configured to activate one or both brake actuator units in order to impart a braking force to an associated wheel, and at least one mechanically actuatable electrical switch that is configured to close and/or open an additional signal line to at least one of the brake actuator units in order to activate the brake actuator thereof.

### CROSS-REFERENCE TO RELATED APPLICATION

This application claims priority to German Priority Application No. 102022104851.9, filed Mar. 1, 2022, the disclosure of which is incorporated herein by reference in its entirety.

### TECHNICAL FIELD

The disclosure relates to a brake-by-wire system for a vehicle.

### BACKGROUND

In modern vehicles, individual wheels are each assigned a brake actuator unit with an electromechanical brake actuator. Such brake systems are referred to as “brake-by-wire” systems.

In such systems, a brake pedal is used merely to interrogate a braking demand of a driver of the vehicle. On the basis of this braking demand, the individual brake actuator units are then activated by one or more electronic control units. There is no mechanical connection between the brake pedal and the brake actuator units.

Since a brake system is a safety-relevant device of a vehicle, it is common for at least certain components or functions to be implemented redundantly within the brake system, such that the brake system can operate reliably even in the event of a malfunction or a defect. In other words, redundancies are provided within a brake system in order to achieve high operational reliability.

In previous “brake-by-wire” systems, it has for example been the case that an additional hydraulic brake device is provided as a fall-back level.

This is however associated with high complexity and costs. Furthermore, additional structural space is required, and the weight of the vehicle is increased.

### SUMMARY

What is needed is to provide a brake system which is particularly reliable and which allows safe onward travel even in the event of a partial failure of the system.

Accordingly, a brake-by-wire brake system for a vehicle having at least two wheels which can be braked is disclosed herein. The brake system comprises at least two brake actuator units, which each having a brake actuator assigned to one of the wheels, which can be braked, for the purposes of braking the vehicle during a driving operation. The brake system furthermore comprises a brake actuation unit for actuation by the driver for a braking operation, having at least one sensor for detecting an activation of the brake actuation unit by the driver, and comprises at least one electronic control unit which is configured to activate one or both brake actuator units in order to impart a braking force to an associated wheel. The brake system furthermore comprises at least one mechanically actuatable electrical switch that is configured to close and/or open an additional signal line to at least one of the brake actuator units in order to activate the brake actuator thereof.

The additional switch forms a fall-back level for the situation in which the activation of the brake actuator units by the at least one control unit is no longer possible, for example because the energy supply of the at least one control unit and/or of the at least one sensor of the brake actuation unit have failed, or signal lines between the control unit and the brake actuator units or the at least one sensor are defective. In exemplary arrangement, the switch allows an emergency braking operation, and thus makes it possible for the vehicle to be safely brought to a standstill if required.

Such a mechanical switch is particularly advantageous, because no hydraulic fall-back level is required.

For example, there is no hydraulic or other mechanical connection between the brake actuation unit and the brake actuators for the purposes of transmitting force.

In one exemplary arrangement, the brake actuation unit is a dry design, that is to say it does not contain any hydraulic fluid.

By virtue of the fact that the fall-back level is based on a different actuation principle than the activation by a control unit, the likelihood of a double failure is also reduced.

The brake system can thus be a compact design, and a vehicle weight can be considerably reduced in relation to the use of a hydraulic system.

Owing to the mechanical actuation, the switch is independent of an energy supply.

The additional signal line may be connected to a ground terminal. In this way, no dedicated voltage supply is required for the additional signal line. In one exemplary arrangement, the electrical potential of the ground terminal is provided on the signal line. This likewise contributes to a simple and compact design of the brake system.

For example, the switch has at least one normally-open contact and/or at least one normally-closed contact. This contributes to achieving that an actuation of the mechanical switch, and a corresponding signal, can be particularly reliably identified.

If at least one normally-open contact and/or at least one normally-closed contact are present, two parallel-running signal lines to at least one brake actuator unit are present at least in certain portions.

According to one aspect, the switch is actuatable by the brake actuation unit. This is particularly intuitive for the driver, because they can always actuate the brake actuation unit in order to initiate a braking operation. Specifically, the brake actuation unit may comprise a brake pedal, and the mechanical switch is actuatable by actuation of the brake pedal.

A mechanism for actuating the electrical switch has an integrated dead travel, and the switch is actuatable by the brake actuation unit only after the dead travel has been overcome. This means that the electrical switch closes only when the brake actuation unit has been actuated to such an extent as to overcome the dead travel. Specifically, the brake pedal of the brake actuation unit must initially be depressed by a certain distance before the electrical switch can be actuated.

The dead travel relates only to the actuation of the switch, not to the normal functioning of the brake actuation unit. That is to say, an activation of the brake actuation unit by the driver is detected even when the dead travel has not been overcome. In the absence of a failure or partial failure of the brake system, the control unit in this case activates the brake actuator units correspondingly.

According to one aspect, the brake actuator units are configured to take a signal received as a result of actuation of the switch into consideration only if an activation of the brake actuator units by the control unit is impaired. This eliminates the need for a brake actuator unit to simultaneously process two different signals, one from the control unit and one from the additional signal line.

The actuation of the switch may however serve for checking the plausibility of a braking demand whilst the brake actuator unit is being activated by the control unit.

In one exemplary arrangement, each of the at least two brake actuator units is configured to take a signal received as a result of actuation of the switch into consideration only if an activation of the two brake actuator units by the control unit is impaired.

The at least two brake actuator units may be connected by a communication line. The brake actuator units can communicate with one another, to establish whether the respective other brake actuator unit is active.

An energy store, for example a capacitor and/or a storage battery, may be integrated in the brake actuator units. The energy store can supply sufficient energy to the electronics of the brake actuator units to initiate at least one final emergency braking operation if the brake actuator unit has been cut off from a main energy store.

According to one exemplary arrangement, at least two mechanically actuatable electrical switches are present, which are arranged at different points of the travel of the brake actuation unit. The two switches are consequently actuated in succession, or only one switch is actuated, depending on the intensity with which a driver actuates the brake actuation unit. This allows the braking force to be metered to a certain degree even during an emergency braking operation. That is to say, a greater braking force is generated when both switches are actuated than when only one switch is actuated.

The sensor, the control unit and/or the energy supply of the brake actuator units may be provided in each case in redundant form. An additional fall-back level is thus implemented, whereby the fail-safety of the brake system is further increased.

In one exemplary arrangement, the brake system has four wheels, which can be braked, and four brake actuator units, each wheel being assigned a brake actuator unit, and the brake system having a first energy supply unit and a second energy supply unit, which each supply energy to the brake actuator units of two diagonally oppositely situated wheels, each energy supply unit in particular supplying energy to different brake actuator units, and the brake system having a third energy supply unit, which supplies energy to the brake actuator units of two mutually adjacently situated wheels, for example, the front wheels. The third energy supply unit serves for providing an energy supply if the first and the second energy supply unit have failed. By virtue of the third energy supply unit providing a supply to the brake actuator units of two mutually adjacently situated wheels, the vehicle can be brought to a standstill particularly quickly in the event of an emergency braking operation.

Further advantages and features of the disclosure will emerge from the following description and from the single appended drawing, to which reference is made. Said drawing schematically shows a brake system according to the disclosure for a vehicle.

### BRIEF DESCRIPTION OF DRAWINGS

FIG. 1 illustrates an exemplary arrangement of a brake system 10 for a vehicle having four wheels 12, 14, 16, 18 which can be braked.

### DETAILED DESCRIPTION

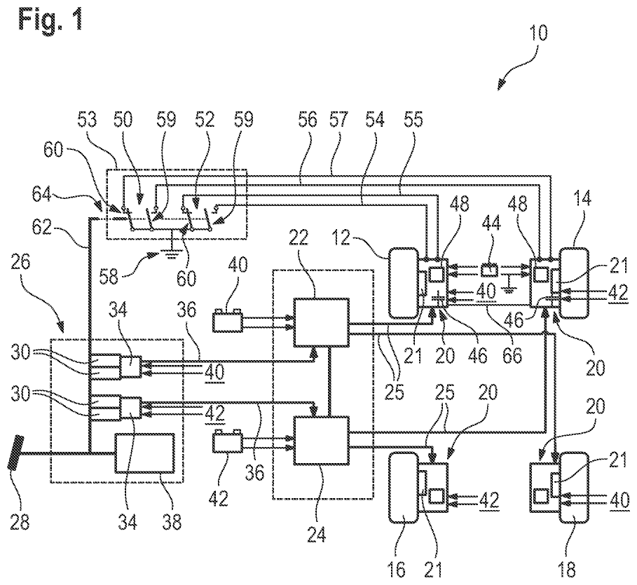

Referring to FIG. 1, in one exemplary arrangement, the vehicle has two front wheels 12, 14 and two rear wheels 16, 18.

Each of the wheels 12, 14, 16, 18 is assigned a brake actuator unit 20. In other words, the brake actuator units 20 are provided at each individual wheel.

The brake actuator units 20 each comprise an electromechanical brake actuator 21 with an electric motor and with a spindle mechanism. No hydraulic actuator is provided.

The brake actuator 21 serves for the braking of the vehicle during driving operation.

In one exemplary arrangement, as illustrated in FIG. 1, the brake system is a dry brake system 10.

The brake actuator units 20 allow for a respective brake pad assigned to a wheel 12, 14, 16, 18 to be moved and pressed against a brake disc for the purposes of braking the vehicle. For the sake of simplicity, the brake pads and brake discs are not illustrated.

The brake system 10 has a first electronic control unit 22 and a second electronic control unit 24 which are each configured to activate two brake actuator units 20 in order to impart a braking force to an associated wheel 12, 14, 16, 18.

As illustrated in FIG. 1, the first control unit 22 and the second control unit 24 respectively activate different brake actuator units 20, which are assigned to diagonally oppositely situated wheels 12, 14, 16, 18.

For this purpose, the control units 22, 24 are in each case connected via signal lines 25, for transmission of signals, to the corresponding brake actuator units 20. Via the signal lines 25, a control signal can be transmitted to the respective brake actuator unit 20.

The two control units 22, 24 are likewise connected to one another for transmission of signals.

In order to be able to generate a brake signal, the brake system comprises a brake actuation unit 26 with a brake pedal 28.

The brake signal is generated by virtue of a driver using their foot to actuate the brake pedal 28 of the brake actuation unit 26 and thus signal their braking demand.

In the exemplary arrangement illustrated, the brake actuation unit 26 comprises four sensors 30, for example position transducers.

The sensors 30 can detect an activation of the brake actuation unit 26 by the driver.

The sensors 30 are of redundant configuration, such that a brake signal can be generated and transmitted even in the event of failure of one sensor 30. In one exemplary arrangement, in each case two sensors 30 are redundant with respect to one another.

In the exemplary arrangement, the output signals of the sensors 30 are firstly detected by a signal processing unit 34 before the signals are transmitted to the control units 22, 24.

The signal processing unit 34 is likewise of redundant configuration.

The signal processing units 34 are connected via communication lines 36, for transmission of signals, to the control units 22, 24.

The brake actuation unit 26 furthermore comprises a braking force simulator 38. This generates an opposing pressure that counteracts the pressure exerted on the brake pedal 28 by the driver.

Furthermore, the brake system 10 has a first energy supply unit 40 and a second energy supply unit 42.

The first energy supply unit 40 supplies energy to the first control unit 22, and the second energy supply unit 42 supplies energy to the second control unit 24.

Furthermore, the first energy supply unit 40 supplies energy to the brake actuator units 20 of two diagonally oppositely situated wheels 12, 18, more specifically to those brake actuator units 20 which are activated by the first control unit 22. This is illustrated in the FIGURE through the multiple use of the reference designation 40. The first energy supply unit 40 is however in fact provided only singly.

Correspondingly, the second energy supply unit 42 supplies energy to the brake actuator units 20 of two further diagonally oppositely situated wheels 14, 16, more specifically to those brake actuator units 20 which are activated by the second control unit 24.

In other words, the energy supply units 40, 42 are connected in a diagonal configuration.

The first energy supply unit 40 and the second energy supply unit 42 furthermore supply energy to a respective signal processing unit 34.

In addition to the first and the second energy supply unit 40, 42, a third energy supply unit 44 is provided.

The third energy supply unit 44 may have a smaller capacity than the first and the second energy supply unit 40, 42.

For example, the third energy supply unit 44 provides a voltage of 5 volts, whilst the first and the second energy supply unit 40, 42 provide a voltage of 40 volts.

The third energy supply unit 44 allows an emergency braking operation, in order to safely park the vehicle, in the event of failure of the first and the second energy supply unit 40, 42.

For example, the third energy supply unit 44 supplies electrical current to the electric motor of the brake actuator 21 in the event of failure of the first and second energy supply units 40, 42.

In the exemplary arrangement, the third energy supply unit 44 supplies energy to the brake actuator units 20 of mutually adjacently situated wheels, for example, the front wheels 12, 14. This means that, in the event of a failure of the first and second energy supply units 40, 42, the front wheels 12, 14 are braked. This is advantageous because higher braking forces are attainable at the front axle.

Furthermore, additional energy stores 46 are integrated into two of the brake actuators 20, in the exemplary arrangement into the brake actuator units 20 that are assigned to the front wheels 12, 14.

The energy store 46 may be a capacitor or a storage battery, for example a lead-acid storage battery, lithium-ion storage battery, power cap, or some other electrical store.

The energy stores 46 supply energy in particular to control electronics 48 of the brake actuator units 20.

In the exemplary arrangement, the brake system 10 additionally comprises two mechanically actuatable electrical switches 50, 52.

The switches 50, 52 are each configured to close an additional signal line 54, 56 to a respective one of the brake actuator units 20 in order to activate the brake actuator thereof.

At the same time, each switch 50, 52 opens a further signal line 55, 57 to a respective brake actuator unit 20.

The signal lines 54, 55, 56, 57 run, in hard-wired form, to the brake actuator units 20.

In the exemplary arrangements, the brake actuator units 20 assigned to the front wheels 12, 14 are activated, though it is for example also possible for the brake actuator units 20 of the rear wheels 16, 18 or the brake actuators of a front wheel 12, 14 and of a rear wheel 16, 18 to be activated.

Furthermore, the number of electrical switches 50, 52 may vary, that is to say only one electrical switch may be provided, or more than two electrical switches may be provided.

In the exemplary arrangement, the switches 50, 52 are arranged in a switch box 53.

In the exemplary arrangement, the additional signal lines 54, 55, 56, 57 are connected to a ground terminal 58.

In the exemplary arrangement, each of the two switches 50, 52 has a normally-open contact 59 and a normally-closed contact 60. In this way, each of the switches 50, 52 can, as already mentioned above, close one signal line 55, 57 and simultaneously open a further signal line 54, 56.

The switches 50, 52 are actuatable by the brake actuation unit 26, more specifically by the brake pedal 28.

However, a mechanism 62 for actuating the electrical switches 50, 52 has an integrated dead travel 64. The electrical switches 50, 52 are actuatable by the brake actuation unit 26 or by the brake pedal 28 only after the dead travel 64 has been overcome.

The actuation of the switches 50, 52 takes place for example toward the end of an actuation travel of the brake pedal 28.

When a switch 50, 52 is actuated, the associated brake actuator unit 20 receives a switching signal via the additional signal lines 54, 55, 56, 57.

The two brake actuator units 20 that can be activated by the switches 50, 52 are however configured to take a signal received as a result of actuation of the associated switch 50, 52 into consideration only if an activation of the brake actuator units 20 by the control units 22, 24 is impaired.

During normal, fault-free operation of the brake system 10, both control units 22, 24 activate in each case two brake actuator units 20.

If a first control path has failed, for example owing to a failure of one of the two energy supply units 40, 42, one of the two control units 22, 24, two sensors 30, or at least one communication line 25, 36, this is referred to as a partial failure of the brake system 10.

In this case, two diagonally oppositely situated wheels 12, 14, 16, 18 are still activated by way of the second control path. A controlled braking operation is thus still possible. Onward travel can thus be made possible, possibly with limitations such as a limited vehicle speed or a defined remaining travelling distance. For example, a journey can be continued to a destination or to a workshop.

If the second control path also fails after the first control path, the mechanically actuatable switches 50, 52 serve as a fall-back level. The switches 50, 52 in particular allow an emergency braking operation or safe parking of the vehicle, also referred to as “limp aside”.

If one of the two brake actuator units 20 receives a signal only from the switches 50, 52 but not from the control unit 22, 24, it is established that at least one control path has failed.

From the changeover of the switches 50, 52 and corresponding closure and/or opening of the additional signal line 54, 55, 56, 57, the respective brake actuator unit 20 however identifies that a driver has activated the brake actuation unit 26 for a braking operation, but no corresponding activation by a control unit 22, 24 has taken place.

In this case, the affected brake actuator unit 20 will communicate via a communication line 66 with a further brake actuator unit 20, which receives its control signal from another of the two control units 22, 24.

In this way, the affected brake actuator unit 20 can identify whether the further control path has also failed, or whether the further brake actuator unit 20 is still receiving a control signal.

If neither brake actuator unit 20 has received a signal from one of the control units 22, 24, the brake actuator units 20 will initiate a braking operation in the event of actuation of the switches 50, 52.

If both control paths have failed, the fact that an actuation of the brake actuation unit 26 initially does not result in a braking operation means that the driver will intuitively actuate the brake actuation unit 26 with greater intensity, and thus overcome the dead travel 64, whereby the switches 50, 52 are actuated.

In a further exemplary arrangement, which for the sake of simplicity is not illustrated, further switches may be arranged at different points of the travel of the brake actuation unit 26. These switches are not actuated at the same time as the switches 50, 52, but are for example closed later than the first switches 50, 52 if a driver actuates the brake actuation unit 26 further, that is to say depresses the brake pedal 28 yet further, after the first switches 50, 52 have switched.

The above-described principle according to the disclosure of utilizing a mechanically actuatable electrical switch as a fall-back level is not restricted to use in a dry brake system.

Such a fall-back level may also be utilized in combination with a hydraulic or mixed brake actuator system.

As a further alternative, the brake actuator system may be of central or partially central configuration. This means that one brake actuator unit controls multiple wheels. A central or partially central configuration may be used primarily in the case of hydraulic systems.

1. A brake-by-wire brake system for a vehicle having at least two wheels which can be braked, comprising:
at least two brake actuator units, which each have a brake actuator assigned to one of the wheels, which can be braked, for the purposes of braking the vehicle during a driving operation,
a driver brake actuation unit for actuation by a driver for a braking operation, the driver brake actuation unit having at least one sensor for detecting an activation of the driver brake actuation unit by the driver,
at least one electronic control unit which is configured to activate one or both brake actuator units in order to impart a braking force to an associated wheel, and
at least one mechanically actuatable electrical switch that is configured to close and/or open an additional signal line to at least one of the brake actuator units in order to activate the brake actuator thereof.

2. The brake system according to claim 1, wherein the additional signal line is connected to a ground terminal.

3. The brake system according to claim 1, wherein the switch has at least one normally open contact and/or at least one normally closed contact.

4. The brake system according to claim 1, wherein the switch is actuatable by the driver brake actuation unit.

5. The brake system according to claim 4, wherein a mechanism for actuation of the electrical switch has an integrated dead travel, and the switch is actuatable by the driver brake actuation unit only after the dead travel has been overcome.

6. The brake system according to claim 1, wherein the brake actuator units are configured to take a signal received as a result of actuation of the switch into consideration only if an activation of the brake actuator units by the control unit is impaired.

7. The brake system according to claim 1, wherein the at least two brake actuator units are connected by a communication line.

8. The brake system according to claim 1, wherein an energy store is integrated into the brake actuator units.

9. The brake system according to claim 1, wherein at least two mechanically actuatable electrical switches are provided, which are arranged at different points of the travel of the brake actuation unit.

10. The brake system according to claim 1, wherein the sensor, the control unit and/or the energy supply of the brake actuator units are provided in each case in redundant form.

11. The brake system according to claim 1, wherein the brake system has four wheels, which can be braked, and four brake actuator units, each wheel being assigned a brake actuator unit, and the brake system having a first energy supply unit and a second energy supply unit, which each supply energy to the brake actuator units of two diagonally oppositely situated wheels, and the brake system having a third energy supply unit, which supplies energy to the brake actuator units of two mutually adjacently situated wheels.

12. The brake system according to claim 2, wherein the switch has at least one normally open contact and/or at least one normally closed contact.

13. The brake system according to claim 12, wherein is actuatable by the driver brake actuation unit.

14. The brake system according to claim 13, wherein a mechanism for actuation of the electrical switch has an integrated dead travel, and the switch is actuatable by the driver brake actuation unit only after the dead travel has been overcome.

15. The brake system according to claim 12, wherein the brake actuator units are configured to take a signal received as a result of actuation of the switch into consideration only if an activation of the brake actuator units by the control unit is impaired.

16. The brake system according to claim 15, wherein the at least two brake actuator units are connected by a communication line.

17. The brake system according to claim 8, wherein the energy store comprises a capacitor and/or a storage battery.
